(19) United States
(12) Patent Application Publication
(10) Pub. No.: US 2012/0036928 A1
(43) Pub. Date: Feb. 16, 2012

(54) LIQUID VOLUME INSPECTION DEVICE WITH IMPROVED FLOATING BALL

(76) Inventor: Jui-Yang LO, Junghe City (TW)

(21) Appl. No.: 12/856,245

(22) Filed: Aug. 13, 2010

(51) Int. Cl. G01F 23/30

(52) U.S. Cl. 73/305

(57) ABSTRACT

A liquid volume inspection device with improved floating ball is disclosed which comprises an internal pipe, a coil wound about the outside of the internal pipe, an external sleeve, an improved floating ball, a base and an upper fixer, in which a magnetic inductor is accommodated within the improved floating ball, the improved floating ball is installed within the internal pipe, the upper end of the internal pipe is fixedly connected in screw with the upper fixer and the lower end of the internal pipe is fixedly connected to the base; when a liquid flows into the internal pipe, the improved floating ball floats in the internal pipe, thereby forming a smaller contact area between the inner wall of the internal pipe and the improved floating ball, so that the surface of the improved floating ball is not attachable to the inner wall of the internal pipe, and the improved floating ball is allowed to change the position thereof in real-time according to the elevation of the liquid level; then the variation of electrical induction in the magnetic inductor can be induced through the coil and the liquid volume therein can be shown on the external display panel through circuitry conversion.

### BACKGROUND OF THE INVENTION

1. Field of the Invention

The present invention relates to a liquid volume inspection device with improved floating ball; in particular, to an improved floating ball for a liquid volume inspection device in which a smaller contact area is formed between the improved floating ball and the inner wall of the internal pipe such that, when a liquid flows into the internal pipe of the liquid volume inspection device, the problems such as the retardation of floating ball movement caused by the liquid and so forth can be prevented.

2. Description of Related Art

The inventor of the present invention has previously filed a patent application for a liquid volume inspection device 1 (ROC Patent Publication No. 388505) which comprises an internal pipe 11, a coil 12 wound about the outside of the internal pipe 11, an external sleeve 13, a floating ball 14, a base 15 and an upper fixer 16, wherein the floating ball 14 is installed within the internal pipe 11 externally wound with the coil, the external sleeve 13 is installed in set onto the outside of the internal pipe 11, the upper end of the internal pipe 11 is fixedly connected in screw with the upper fixer 16, the lower end of the internal pipe 11 is fixedly connected to the base 15, and the both ends of the external sleeve 13 are closed with sealing glue for protecting the coil 12 wound about the external periphery of the internal pipe 11; hence, when performing liquid volume inspection by using the structure of the aforementioned liquid volume inspection device 1, as a liquid enters into the internal pipe 11 via the permeation hole 151 in the base 15, the floating ball 14 in the internal pipe 11 can change the position thereof according to the elevation of the liquid level, thus the variation of electrical induction can be induced through the coil and the liquid volume therein can be shown on an external display panel 17 by means of circuitry conversion (see FIG. 1).

However, the floating ball used in the liquid volume inspection device is a cylinder-like floating ball, in which a small gap is formed between the surface of the cylinder-like floating ball and the inner wall of the internal pipe; when the liquid volume is reduced, the surface of the cylinder-like floating ball can be attached to the inner wall of the internal pipe rather than falling down due to liquid attaching force, so it is necessary to wait until such a liquid attaching force becomes weaker as the liquid is reduced to a certain extent, thus the cylinder-like floating ball dropping to the liquid level because of gravity, which drawback in consequence undesirably compromising the precision of the liquid volume inspection device.

Therefore, it is preferable to provide a liquid volume inspection device with improved floating ball which is directed to reduce the attachment of the floating ball onto the inner wall of the internal pipe due to such a liquid attaching force and to prevent the problem of precision loss in the liquid volume inspection device because that the floating ball is unable to displace in real-time as the elevation of the liquid level varies.

### SUMMARY OF THE INVENTION

The objective of the present invention is to provide a liquid volume inspection device with improved floating ball which is directed to reduce the contact area between the surface of the floating ball and the inner wall of the internal pipe thereby preventing the attachment of the surface of the floating ball onto the inner wall of the internal pipe and allowing the floating ball in the internal pipe to displace in real-time according to the elevation of the liquid level.

Another objective of the present invention is to provide a liquid volume inspection device with improved floating ball which allows to prevent the consequence of precision loss in the liquid volume inspection device because that the floating ball is unable to precisely displace in real-time according to the elevation of the liquid level.

In order to achieve the aforementioned objectives, a liquid volume inspection device with improved floating ball according to the present invention is provided which comprises an internal pipe, a coil wound about the outside of the internal pipe, an external sleeve, an improved floating ball, a base and an upper fixer, in which a smaller contact area is formed between the improved floating ball and the inner wall of the internal pipe, a magnetic inductor is accommodated within the improved floating ball, the improved floating ball is installed within the internal pipe, the upper end of the internal pipe is fixedly connected in screw with the upper fixer, and the lower end of the internal pipe is fixedly connected to the base; when a liquid flows into the internal pipe, the improved floating ball floats in the internal pipe, thus a smaller contact area is formed between the surface of the oval structure of the improved floating ball and the inner wall of the internal pipe, such that the improved floating ball is allowed to change the position thereof in real-time according to the elevation of the liquid level, so the variation of electrical induction in the magnetic inductor can be induced through the coil and the liquid volume therein can be shown on the external display panel through circuitry conversion.

More specifically, the surface of the improved floating ball according to the present invention is oval, rhombus and the like which constitutes a structure having a smaller contact area with the inner wall of the internal pipe.

More specifically, the improved floating ball according to the present invention has a combinatorial structure, so the improved floating ball consists of an upper sphere, a lower sphere and a magnetic inductor, in which the upper sphere and the lower sphere are hollow hemispheres, and the magnetic inductor is contained between the upper sphere and the lower sphere.

In addition, the upper sphere has a screw-like bulge and the lower sphere has a corresponding screw-like groove, such that the screw-like bulge of the upper sphere enables fixed connection of the upper sphere and the lower sphere in screw along the screw-like groove.

More specifically, the improved floating ball according to the present invention has a single-piece structure, and a magnetic inductor is installed within the improved floating ball.

More specifically, the improved floating ball according to the present invention is made of a material with a density lower than the entering liquid thereby allowing the improved floating ball to float on the liquid level.

More specifically, the magnetic inductor according to the present invention is made of a magnetic induction material, so, when the position of the improved floating ball varies, the variation of electrical induction in the magnetic inductor can be induced through the coil and the liquid volume is shown on the external display panel.

### BRIEF DESCRIPTION OF THE DRAWINGS

FIG. 1 shows a diagram for the integral structure of a conventional liquid volume inspection device;

FIG. 2 shows a diagram for the integral structure of a liquid volume inspection device according to the present invention;

FIG. 3A shows a diagram for the structure of the improved floating ball in the liquid volume inspection device with improved floating ball according to the present invention;

FIG. 3B shows a combinatorial diagram for the improved floating ball in the liquid volume inspection device with improved floating ball according to the present invention; and

FIG. 4 shows a diagram for an embodiment of the liquid volume inspection device with improved floating ball according to the present invention.

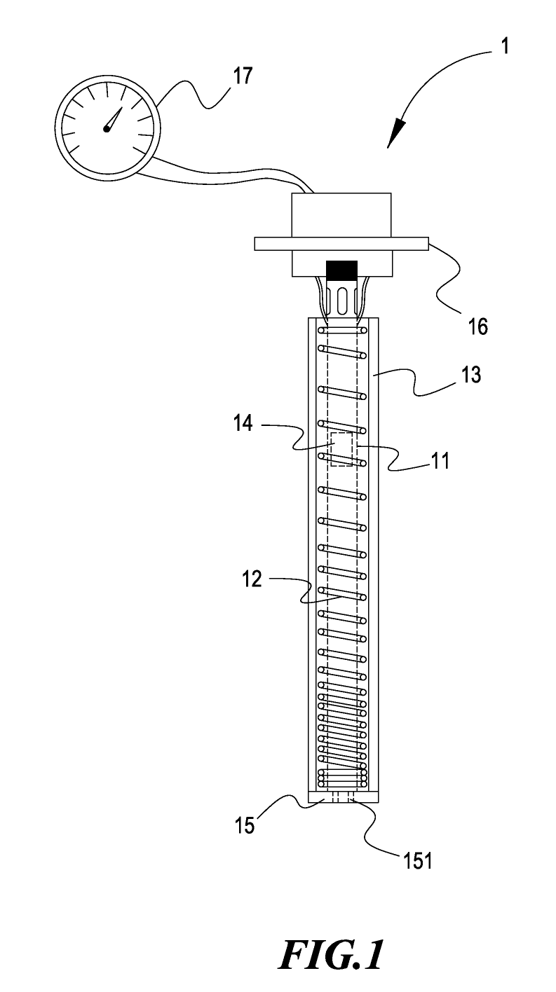

### DETAILED DESCRIPTION OF THE PREFERRED EMBODIMENTS

By referring to the detailed descriptions for the preferred embodiments of the present invention, in conjunction with the appended drawings, the aforementioned and other technical contents, features and effects of the present invention can be clearly presented.

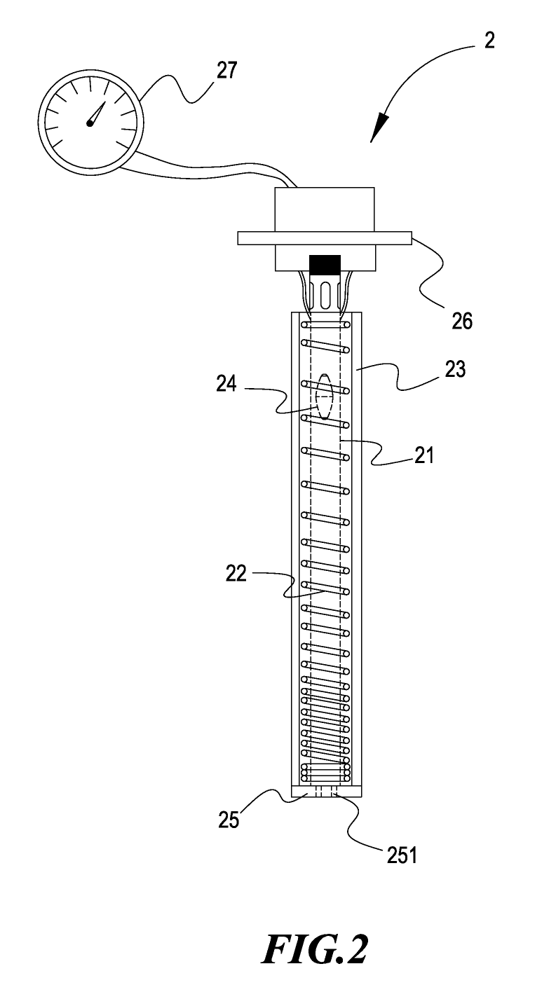

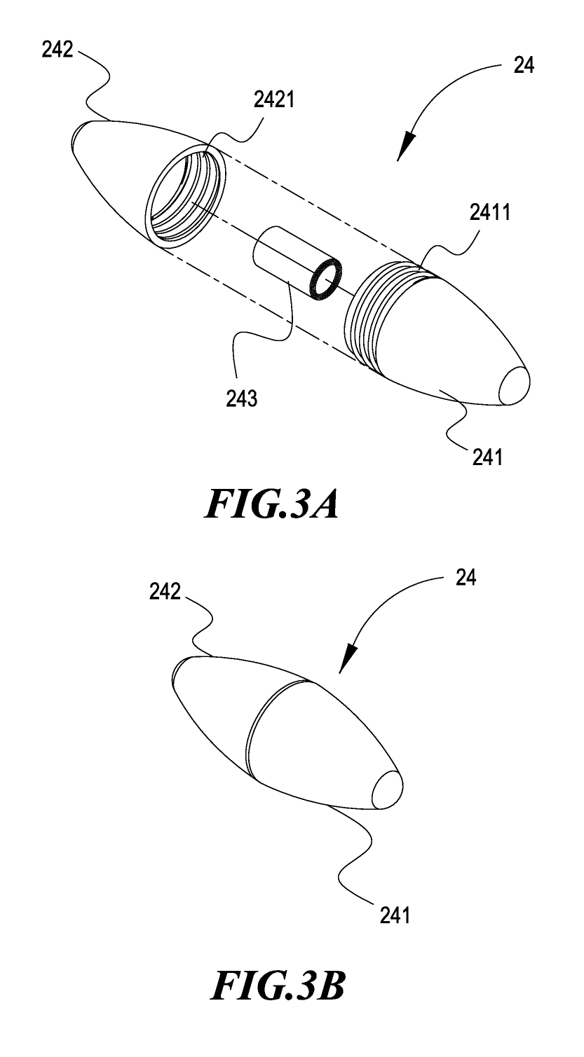

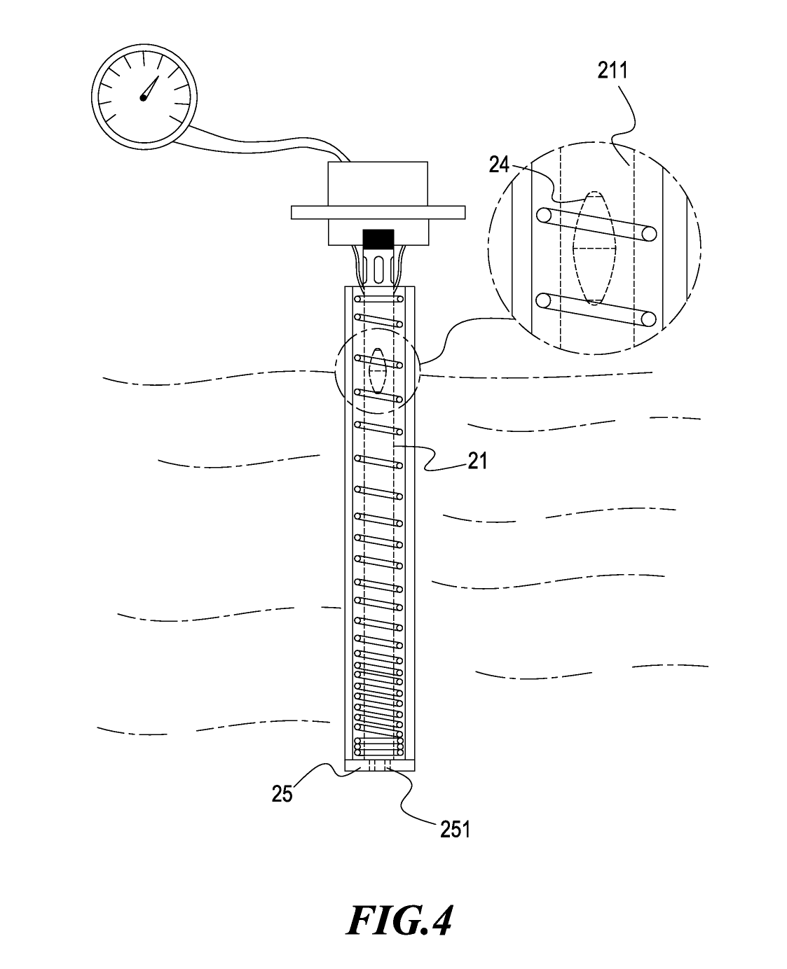

Refer now to FIGS. 2, 3A and 4, wherein the diagram for the integral structure, the diagram for the structure of the improved floating ball and the diagram for an embodiment of a liquid volume inspection device with improved floating ball according to the present invention are respectively shown. From the Figures, it can be seen that the liquid volume inspection device 2 with improved floating ball according to the present invention comprises an internal pipe 21, a coil 22 wound about the outside of the internal pipe 21, an external sleeve 23, an improved floating ball 24, a base 25 and an upper fixer 26, wherein the surface of the improved floating ball 24 and the inner wall 211 of the internal pipe 21 conjunctively form a smaller contact area, a magnetic inductor 243 is accommodated within the improved floating ball 24, and also the improved floating ball 24 is installed within the internal pipe 21, with the upper end of the internal pipe 21 being fixedly connected in screw with the upper fixer 26, the lower end of the internal pipe 21 being fixedly connected to the base 25, and the both ends of the internal pipe 21 being closed with sealing glue for protecting the coil 22 wound about the external periphery of the internal pipe 21.

When a liquid enters into the internal pipe 21 via the permeation hole 251 in the base 25, the improved floating ball 24 floats in the internal pipe 21 and a smaller contact area is thus formed between the surface of the improved floating ball 24 and the inner wall 211 of the internal pipe 21, such that the improved floating ball 24 is allowed to change the position thereof according to the elevation of the liquid level 3, thereby the coil 22 can induce the variation of electrical induction in the magnetic inductor 243 so the liquid volume therein can be shown on an external display panel 27 through circuitry conversion.

It should be noted that the surface of the improved floating ball 24 is oval, rhombus and the like which constitutes a structure having a smaller contact area with the inner wall 211 of the internal pipe 21.

It should be noted that the improved floating ball 24 has a combinatorial structure, so the improved floating ball 24 consists of an upper sphere 241, a lower sphere 242 and a magnetic inductor 243, in which the upper sphere 241 and the lower sphere 242 are hollow hemispheres, and the magnetic inductor 243 is contained between the upper sphere 241 and the lower sphere 242. In addition, the upper sphere 241 has a screw-like bulge 2411 and the lower sphere 242 has a corresponding screw-like groove 2421, such that the screw-like bulge 2411 of the upper sphere 241 enables fixed connection of the upper sphere 241 and the lower sphere 242 in screw along the screw-like groove 2421.

It should be noted that the improved floating ball 24 has a single-piece structure, and a magnetic inductor 243 is installed within the improved floating ball 24.

It should be noted that the improved floating ball 24 is made of a material with a density lower than the entering liquid thereby allowing the improved floating ball 24 to float on the liquid level 3.

It should be noted that the magnetic inductor 243 is made of a magnetic induction material, so, when the position of the improved floating ball 24 varies, the coil 22 is able to induce the variation of electrical induction in the magnetic inductor 243 and the liquid volume is shown on the external display panel 27.

Compared with prior art, the liquid volume inspection device with improved floating ball according to the present invention provides the following advantages:

1. with a smaller contact area between the surface of the improved floating ball and the inner wall of the internal pipe, the surface of the improved floating ball is less likely to be attached to the inner wall of the internal pipe as the liquid level falls, thus enabling real-time displacement of the improved floating ball in the internal pipe in accordance with the liquid level;

2. since the present invention allows to prevent the inaccuracy caused by incapability of real-time displacement regarding to the position of the improved floating ball in accordance with the elevation of the liquid level, consequently, in performing liquid inspection with the liquid volume inspection device, it is possible to reduce or eliminate the problem of precision loss and error in the liquid volume inspection device.

Through the detailed descriptions of the preferred embodiments illustrated as above, it is intended that the features and spirit of the present invention can be clearly set forth by means of the preferred embodiments herein disclosed, rather than limiting the scope of the present invention thereto. Furthermore, the purpose of the aforementioned descriptions is to encompass all effectively equivalent modifications and alternations made or arranged within the scope of the present invention as delineated in the following claims.

What is claimed is:

1. A liquid volume inspection device with improved floating ball comprises an internal pipe, a coil wound about the outside of the internal pipe, an external sleeve, an improved floating ball, a base and an upper fixer, characterized in that: the improved floating ball is installed within the internal pipe, a smaller contact area is formed between the inner wall of the internal pipe and the surface of the improved floating ball, so when a liquid flows into the internal pipe from the base, the improved floating ball is allowed to change the position thereof in real-time according to the elevation of the liquid level, and a magnetic inductor is installed within the improved floating ball such that the variation of electrical induction in the magnetic inductor can be induced through the coil wound about the outside of the internal pipe.

2. The liquid volume inspection device with improved floating ball according to claim 1, wherein the surface of the improved floating ball is oval, rhombus and the like which constitutes a structure having a smaller contact area with the inner wall of the internal pipe.

3. The liquid volume inspection device with improved floating ball according to claim 1, wherein the improved floating ball has a single-piece structure.

4. The liquid volume inspection device with improved floating ball according to claim 1, wherein the improved floating ball has a combinatorial structure, and the improved floating ball consists of an upper sphere, a lower sphere and a magnetic inductor, in which the upper sphere and the lower sphere are hollow hemispheres, and the magnetic inductor is contained between the upper sphere and the lower sphere.

5. The liquid volume inspection device with improved floating ball according to claim 4, wherein the upper sphere has a screw-like bulge and the lower sphere has a corresponding screw-like groove, such that the screw-like bulge of the upper sphere enables fixed connection of the upper sphere and the lower sphere in screw along the screw-like groove.

6. The liquid volume inspection device with improved floating ball according to claim 1, wherein the improved floating ball is made of a material with a density lower than the entering liquid.

7. The liquid volume inspection device with improved floating ball according to claim 1, wherein the magnetic inductor is made of a magnetic induction material and the variation of electrical induction in the magnetic inductor can be induced through the coil wound about the outside of the internal pipe.
